(19) United States
(12) Patent Application Publication
(10) Pub. No.: US 2009/0071377 A1
(43) Pub. Date: Mar. 19, 2009

(54) Binder for Refractory Concrete, Preparation for Refractory Concrete, Refractory Concrete and Method for Making Same

(75) Inventors: Christoph Wohrmeyer, Lyon (FR); Fabien Simonin, Lyon (FR); Chris Parr, Chatou (FR); Eric Frier, Brignais (FR); Farida Ben Yahia, Villeurbanne (FR)

Correspondence Address: YOUNG & THOMPSON, 209 Madison Street, Suite 500, ALEXANDRIA, VA, 22314, US

(73) Assignee: KERNEOS, Neuilly-sur-Seine (FR)

(21) Appl. No.: 12/282,073

(22) PCT Filed: Mar. 5, 2007
(86) PCT No.: PCT/FR2007/050879

§ 371 Date: Sep. 8, 2008

(30) Foreign Application Priority Data
Mar. 7, 2006 (FR) 0650789

(51) Int. Cl. C04B 40/00; C08K 3/22; C04B 7/32; C04B 28/06

(52) U.S. Cl. 106/693; 106/819; 106/823; 524/433; 106/692

(57) ABSTRACT

The present invention relates to a hydraulic binder for low-cement content concrete. The ground mineral portion of this cement comprises an under-calcinated alumina the BET specific surface of which ranges between 8 m²/g and 20 m²/g. Said binder enables to formulate a concrete the use properties of which remain stable and constant whatever the type of silica fume used, and capable of being used over a wide working temperature range for implementation.

The invention also relates to a preparation for refractory concrete, a refractory concrete and a method for making a refractory concrete.

The present invention relates to refractory concretes, in particular monolithic with low or ultra-low cement content, comprising silica fume.

Low-cement content refractory concretes are known: such concretes comprise for instance the following composition, by weight percentage based on the total weight of concrete:
80% 0-6 mm aggregates,
10% fine alumina,
5% silica fume
5% calcium aluminates,
0.1% adjuvants, and
5 to 6% water,

Silica fume maximises granular stacking of concrete, which enables to use a small amount of water and to improve the rheologic behaviour of concrete. Silica fume thus contributes to the realisation of low-cement content dense concretes.

Moreover, after installation and hardening, silica fume contributes to the formation of particular refractory phases which enable, in particular, good resistance to abrasion.

When implementing low-cement content refractory concretes, a large variability in the properties of the concretes obtained may be observed, in relation to for instance the type and the quality of the silica fume or the alumina used.

Variability in workability of low-cement content concretes may also be observed in relation to the implementation temperature.

For example, low-cement content refractory concretes, comprising sodium phosphates or polyacrylates as adjuvant have been developed. Such concretes exhibit variations in characteristics according to the type of silica fume used, and are sensitive to the implementation working temperature of concrete.

Thus, when the type of alumina or silica fume used changes, it is often necessary to vary the composition of the refractory concrete, and in particular the adjuvant content, for maintaining stable and constant the use properties of concrete from one production batch to another. This implies the realisation of numerous tests, which may prove costly. Moreover, the use of adjuvants enables to improve the rheology delays the hardening process even if they increase the fluidity of concretes.

In certain cases, when the silica fume used is of lesser quality, the production of concretes having acceptable properties in terms of hardening or of rheology is even impossible.

Still, the quality of the silica fumes available for the manufacture of refractory concretes is quite variable, in relation to their origin and production. There are thus silica fumes whereof the pH, the impurities ratio or still the size distribution vary a lot in relation to the origin thereof.

Therefore, there is a need for new refractory concrete the use properties of which remain stable and constant whatever the type of silica fume used for their manufacture, and capable of being used over a wide working temperature range for implementation.

These advantages are designated by the expression “robustness” which defines the ability of the concrete to possess good use properties in terms of workability or hardening for instance, even when the quality of certain components of the composition varies or when their implementation working temperature varies.

The applicant has developed a hydraulic binder for low-cement content refractory concrete containing silica, meeting the constraints described above, said binder comprising:
a ground mineral portion comprising 30% to 80% by weight based on the total weight of said ground mineral portion, a clinker comprising 60% to 80% by weight Al₂O₃, and 40% or less CaO,
at least one setting accelerator,
at least one setting retarder,
at least one defloculating agent.

According to the invention, said ground mineral portion further comprises 20% to 70% by weight, based on the total weight of said ground mineral portion, an under-calcinated alumina the BET specific surface of which ranges between 8 m²/g and 20 m²/g, and preferably between 10 m²/g and 15 m²/g.

Most preferably, the BET specific surface ranges between 10 m²/g and 12 m²/g.

According to the invention, the term “implementation working temperature” means the temperature at which the concrete is mixed and cast.

The expression “BET specific surface” designates the external and internal total mass surface area of a solid according to the method invented by Brunauer, Emmett and Teller (BET). The BET specific surface does not measure the closed porosity. The Brunauer, Emmett et Teller method (BET) is described in the ISO 9277:1995 standard.

According to the invention, the term “under-calcinated alumina” means alumina obtained by curing, while varying the temperature and the curing time, so that all the alumina is not transformed into alumina α. Thus, during curing, the under-calcinated alumina is partially, but not completely transformed into alumina α. The alumina not transformed into alumina α during curing is designated as “transition alumina” in the description below.

In a preferred embodiment, the under-calcinated alumina of the binder of the invention comprises 10% to 50% by weight of transition alumina, the remainder being formed of alumina α.

The clinker used comprises the mineralogical phases: CA, CA2 and optionally other phases such as C12A7 and/or an alumina.

An under-calcinated alumina according to the invention can be obtained by mixing several types of alumina with different BET specific surfaces, providing that the mixture obtained exhibits a BET specific surface ranging between 8 m²/g and 20 m²/g, preferably ranging between 10 m²/g and 15 m²/g and, most preferably, ranging between 10 m²/g and 12 m²/g.

The hydraulic binder developed by the applicant is ideal for the realisation of refractory concretes comprising 2.5% CaO or less. Such concretes are designated as “low-cement content concretes” or “low cement castable (LCC)”.

The binder developed by the applicant is also particularly suitable for the realisation of refractory concretes comprising 1% or less CaO. Such concretes are designated as ‘ultra low cement content concretes” or “ultra low cement castable (ULCC)”.

As shown on example 1, the binder defined above enables to realise concretes having satisfactory and constant use properties in particular in terms of workability and hardening even when the type of silica fume used varies.

Similarly, the binder defined above enables to realise concretes having satisfactory and constant properties even when the implementation working temperature of the concrete varies. Thus, in example 2, the applicant has shown that the performance deviations in terms of workability and hardening of the concretes formulated with the binder according to the invention, are reduced whatever the implementation working temperature of the concrete.

Finally, in example 3, the applicant has shown that, when the implementation working temperature of the concrete is low, the concretes formulated with the binder according to the invention exhibit reduced performance deviations in terms of workability and hardening even when the type of silica fume used varies.

Thus, the concrete provided with the binder defined above is particularly robust as regards (i) the type of silica fume used, (ii) the type of aggregates used, and (iii) the implementation working temperature of the concrete.

The ground mineral portion in the composition of the binder may comprise 40% to 60% by weight based on the total weight of said ground mineral portion, clinker, and 60% to 40% by weight based on the total weight of said ground mineral portion, under-calcinated alumina.

Most preferably, the ground mineral portion in the composition of the binder comprises 50% by weight based on the total weight of said ground mineral portion, clinker, and 50% by weight, based on the total weight of said ground mineral portion, under-calcinated alumina.

Most preferably, the under-calcinated alumina comprises:
80 parts by weight of alumina α and
20 parts by weight of transition alumina.

Several types of under-calcinated aluminae are suitable to the realisation of the binder defined above. An alumina having a BET specific surface of 12 m²/g or still an alumina having a BET specific surface of 9 m²/g, may be mentioned

Preferably, said ground mineral portion exhibits a Blaine specific surface of at least 7000 cm²/g.

The binder object of the invention may comprise 0.03% to 1% by weight of setting accelerator, based on the total weight of the ground mineral portion, and preferably 0.3 to 0.5% by weight of setting accelerator based on the weight of the ground mineral portion.

A setting accelerator particularly suitable to the realisation of the binder is a lithium salt, in particular lithium carbonate.

The binder object of the invention may comprise 0.05% to 1.5% by weight, of setting retarder, based on the total weight of the ground mineral portion, and preferably 0.4 to 1.0% by weight, of setting retarder, based on the weight of the ground mineral portion.

Preferably, the setting retarder is a carboxylic acid, and in particular citric acid.

The binder may comprise 0.05% to 2% by weight, of defloculating agent, based on the total weight of the ground mineral portion, and preferably 0.2 to 0.6% by weight, of defloculating agent, based on the weight of the ground mineral portion.

Preferably, the defloculating agent is a polyacrylate, a polycarboxylate polyox (PCP) or a polyphosphate.

The applicant has shown in examples 1 to 3 that the binder defined above, comprising precise quantities of setting accelerator, of setting retarder and defloculating agent, is particularly resistant to the type of silica fume used.

The invention also relates to a preparation for low-cement content concrete comprising, before mixing:
15 to 90% by weight of a binder as defined previously based on the total weight of said preparation and,
10 to 85% by weight of silica fume, based on the total weight of said preparation.

According to the invention, “silica fume” means silica in the form of powder the particles of which have a micrometric or nanometric size. The silica fume implemented can be a silica fume the chemical composition of which complies with the “EN 13263” European standard. The silica implemented may also be precipitate silica.

The invention also relates to a concrete comprising, before mixing:
60 to 90% by weight of aggregates based on the total weight of concrete,
2 to 10%, preferably 3 to 7% by weight of silica fume, based on the total weight of concrete, and
2 to 20% of a binder as defined above based on the total weight of concrete.

Preferably, said concrete comprises:
70 to 90%% by weight of aggregates based on the total weight of concrete,
2% to 10% by weight of silica fume based on the total weight of concrete, and
5 to 15% of a binder as defined above, based on the total weight of concrete.

The invention also relates to a preparation of a binder for low-cement content concrete comprising silica fume, said method comprising the following steps:

(a) co-grinding a mineral portion comprising:
30 to 80% by weight of a clinker comprising 60 to 80% by weight of Al₂O₃, and 40% or less CaO, based on the total weight of said mixture and,
20% to 70% by weight based on the total weight of said mixture, of an under-calcinated alumina the BET specific surface of which ranges between 8 m²/g and 20 m²/g, and preferably ranging between 10 m²/g and 15 m²/g, in order to obtain a ground mineral portion, and

(b) mixing the ground mineral portion obtained with at least one setting accelerator, at least one setting retarder, at least one defloculating agent.

The remainder of the description refers to tables 1 to 5 which represent respectively:
Table 1a: description of the different aluminae used,
Table 1b: description of the different silica fumes used,
Table 2: description of the different types of concretes used, comprising the different types of aluminae described in table 1a,
Table 3: Table 3 illustrates the characteristics of concretes obtained at 20° C. with a binder according to the invention, compared with the characteristics of concretes (A) (with alumina (A)) and different adjuvantation systems, this for 4 different silica fumes (FS(V), FS(W), FS(X), and FS(Z)), defined in table 1b):

i) sodium tripolyphosphate adjuvantation (Na-TPP)

ii) adjuvantation Castament® FS20 from Degussa (FS20®)

iii) Darvan 7S® (sodium polyacrylate, Vanderbuilt)+citric acid (PA+AC)
Table 4: Comparison of the robustness of the concretes according to the invention (concretes (C) and (D)) between 5° C. and 20° C. with two other types of concretes ((A) and (B)) of the prior art.
Table 5: Characteristics of different concretes ((A), (B), (C) and (D)) formulated with FS(V) and FS(W) silica fumes, at 5° C.

### EXAMPLES

In examples 1 to 3, the aluminae (A), (B), (C) and (D) defined in table 1a below have been used:

TABLE 1a

| | alumina (A) | alumina (B) | alumina (C) | Alumina (D) |
|---|---|---|---|---|
| mineralogy | >98% | >95% | 80% | 80% |
| | alumina α | alumina α | alumina α | alumina α |
| state | calcinated | reactive | under- | under- |
| | | | calcinated | calcinated |
| BET (m²/g) | 0.9 | 7.5 | 9 | 12 |
| d50 (μm) | 4 | 0.5 | | |
| Na₂O total | 3700 | 850 | >2000 | >2000 |
| (ppm) | | | | |

d50 (μm): the value of d50 is the particle diameter in μm for which there are 50% in volume of particles having a diameter smaller than the value of d50 specified, and hence 50% in volume for which the diameter is greater than this same value of d50.

A value of d50 equal to 4 means that 50% in volume of the particles are smaller than 4 μm in size.

The particle size distribution of alumina is measured by laser granulometry, with a Coulter LS 230 apparatus, operating as a wet process. The liquid used, wherein the powder is placed, is alcohol.

The alumina (C) and (D) may be used according to the invention. The aluminae (A) and (B) are used in representative examples of the prior art.

In the examples 1 to 3, the FS(V), FS(W), FS(X) and FS(Z) silica fumes defined in table 1b below have been used.

TABLE 1b

| | | FS (V) | FS (W) | FS (X) | FS (Z) |
|---|---|---|---|---|---|
| C free | % | 0.49 | 0.84 | 1.34 | 0.09 |
| pH (10%) | | 6.4 | 8.1 | 7.6 | 2.8 |
| SiO₂ | % | 97.36 | 95.93 | 96.78 | 92.62 |
| Al₂O₃ | % | 0.35 | 0.32 | 0.31 | 0.81 |
| Fe₂O₃ | % | 0.06 | 0.04 | 0.55 | 0.32 |
| CaO | % | 0.06 | 0.32 | 0.21 | 0.00 |
| MgO | % | 0.38 | 0.63 | 0.42 | 0.30 |
| TiO₂ | % | 0.03 | 0.04 | 0.04 | 0.06 |
| Mn₂O₃ | % | 0.01 | 0.05 | 0.04 | 0.01 |
| P₂O₅ | % | 0.06 | 0.12 | 0.02 | 0.28 |
| Cr₂O₃ | % | 0.01 | 0.00 | 0.00 | 0.02 |
| ZrO₂ | % | 0.11 | 0.10 | 0.10 | 4.71 |
| K₂O | % | 0.22 | 0.87 | 0.16 | 0.00 |
| PaF 1000° C. * | % | 0.90 | 1.71 | 1.75 | 0.87 |
| Soluble | % | 0.32 | 0.53 | 0.25 | 0.09 |
| elements (% | | | | | |
| dry matter) | | | | | |

* PaF 1000° C. means << fire loss at 1000° C. >>.

The aluminae (A), (B), (C) and (D) have been used for formulating the concretes of following compositions:

TABLE 2

| | Prior art | | Invention | |
|---|---|---|---|---|
| Type of | Concrete | Concrete | Concrete | Concrete |
| concrete | (A) | (B) | (C) | (D) |
| Tabular | 29 | 29 | 29 | 29 |
| alumina T60 | | | | |
| 6-14 mesh | | | | |
| Tabular | 22 | 22 | 22 | 22 |
| alumina T60 | | | | |
| 14-28 mesh | | | | |
| Tabular | 29 | 29 | 29 | 29 |
| alumina T60 <48 | | | | |
| mesh | | | | |
| Alumina (A) | 10 | 5 | 5 | 5 |
| Alumina (B) | | 5 | | |
| Secar ® 71 | 5 | 5 | | |
| Binder | | | 10 | |
| according to | | | | |
| the invention | | | | |
| with | | | | |
| alumina (C) | | | | |
| Binder | | | | 10 |
| according to | | | | |
| the invention | | | | |
| with | | | | |
| alumina (D) | | | | |
| Silica fumes | 5 | 5 | 5 | 5 |
| (FS(V), | | | | |
| FS(W), FS(X), | | | | |
| or FS(Z)) | | | | |
| water | +5.5% | +5.5% | +5.5% | +5.5% |

For the concretes A and B the adjuvantations used are specified in the examples. For the concretes C and D, the adjuvants are those of the binder according to the invention. All the concretes are formulated with constant CaO content (1.5% CaO).

### Example 1

Table 3 below illustrates the characteristics of concretes obtained at 20° C. with a binder according to the invention, compared with the characteristics of concretes of type (A) (formulated with alumina (A)) and different adjuvantation systems, this for 4 different silica fumes (FS(V), FS(W), FS(X), and FS(Z)):

i) sodium tripolyphosphate adjuvantation (Na-TPP)

ii) adjuvantation Castament® FS20 from Degussa (FS20®)

iii) Darvan 7S® (sodium polyacrylate, Vanderbuilt)+citric acid (PA+AC)

Table 3 shows that the concrete of (D) type formulated with a binder according to the invention exhibit few variations in workability whatever the type of silica fume (FS(V), FS(W), FS(X), and FS(Z)) implemented for the formulation thereof.
By comparison, it may also be observed that the concretes of type (A), representative of the prior art, do not enable to realise concretes the workability of which remains constant when the type of silica fume implemented varies, and this whatever the type of adjuvantation used.

TABLE 3

| | Prior art | | | | | | | |
|---|---|---|---|---|---|---|---|---|
| | Concrete (A) with | | | | Concrete (A) with | | | |
| Tests at | Na-TPP (0.15%) | | | | FS20 ® (0.1%) | | | |
| 20° C. | FS(V) | FS(W) | FS(X) | FS(Z) | FS(V) | FS(w) | FS(X) | FS(Z) |
| flow To (mm) | 242 | 202 | 185 | 250 | 260 | 250 | 247 | 260 |
| flow T15 | 214 | 204 | 195 | 252 | 245 | 240 | 240 | 260 |
| (mm) | | | | | | | | |
| flow T30 | 220 | 178 | 205 | 245 | 245 | 235 | 160 | 247 |
| (mm) | | | | | | | | |
| flow T60 | 165 | | | 250 | 210 | 225 | 165 | 235 |
| (mm) | | | | | | | | |
| workability | 78 | 47 | 55 | 100 | 95 | 165 | 80 | >240 |
| (min) | | | | | | | | |
| Bending | 2.8 | 1.9 | 2.0 | 1.4 | 0.4 | 0.3 | 0.3 | 0.0 |
| strength 6 h | | | | | | | | |
| (MPa) | | | | | | | | |
| Compression | 13 | 8 | 7 | 5 | 2 | 2 | 1 | 0 |
| strength 6 h | | | | | | | | |
| (Mpa) | | | | | | | | |
| Bending | 4.9 | 4.8 | 4.0 | 4.4 | 2.2 | 0.6 | 1.0 | 0.5 |
| strength 24 h | | | | | | | | |
| (Mpa) | | | | | | | | |
| Compression | 25 | 23 | 17 | 19 | 9 | 3 | 4 | 4 |
| strength 24 h | | | | | | | | |
| (Mpa) | | | | | | | | |

| | | |
|---|---|---|
| | Prior art | Invention |
| | Concrete (A) with | Concrete (D) with binder |
| Tests at | PA (0.1%) + AC (0.02%) | according to the invention |

| 20° C. | FS(V) | FS(W) | FS(X) | FS(Z) | FS(V) | FS(W) | FS(X) | FS(Z) |
|---|---|---|---|---|---|---|---|---|
| flow To (mm) | 240 | 235 | 170 | 245 | 222 | 203 | 220 | 238 |
| flow T15 | 160 | 225 | 195 | 240 | 228 | 217 | 230 | 235 |
| (mm) | | | | | | | | |
| flow T30 | 215 | 210 | 215 | 237 | 223 | 213 | 217 | 227 |
| (mm) | | | | | | | | |
| flow T60 | 155 | 150 | 140 | 220 | | | | |
| (mm) | | | | | | | | |
| workability | 80 | 145 | 80 | 240 | 42 | 41 | 40 | 58 |
| (min) | | | | | | | | |
| Bending | 0.5 | 0.4 | 0.3 | 0.0 | 4.1 | 4.0 | 4.0 | 4.0 |
| strength 6 h | | | | | | | | |
| (MPa) | | | | | | | | |
| Compression | 2 | 2 | 1 | 0 | 12 | 12 | 11 | 12 |
| strength 6 h | | | | | | | | |
| (Mpa) | | | | | | | | |
| Bending | 1.0 | 0.9 | 0.7 | 0.2 | 4.4 | 4.4 | 4.7 | 4.8 |
| strength 24 h | | | | | | | | |
| (Mpa) | | | | | | | | |
| Compression | 3 | 3 | 2 | 1 | 15 | 16 | 14 | 16 |
| strength 24 h | | | | | | | | |
| (Mpa) | | | | | | | | |

### Example 2

Example 2 illustrates the robustness of the concretes according to the invention (concretes (C) and (D)) between 5° C. to 20° C., compared to the concretes (A) and (B). For the four type of concretes the adjuvantation used is the same, i.e. that of the binder according to the invention.

TABLE 4

| | | Prior art | | Invention | |
|---|---|---|---|---|---|
| | | Concrete | Concrete | Concrete | Concrete |
| With FS(V) silica fume | | (A) | (B) | (C) | (D) |
| 20° C. | flow To (mm) | 252 | 230 | 205 | 196 |
| | Working time | 1.83 | 1.13 | 0.48 | 0.56 |
| | (h) | | | | |
| | Toff (h) | 2.1 | 1.1 | 0.56 | 0.58 |
| | Rc at 6 h | 10.8 | 11.5 | 12.2 | 12.5 |
| | (Mpa) | | | | |
| 5° C. | flow To (mm) | 248 | 242 | 222 | 226 |
| | Working time | 8.8 | 8 | 3 | 3.2 |
| | (h) | | | | |
| | Toff (h) | 8 | 7.5 | 2 | 2.1 |
| | Rc at 6 h | 0 | 0 | 9.1 | 10.9 |
| | (Mpa) | | | | |
| Δ Toff | | 5.9 | 6.4 | 1.4 | 1.5 |
| (h) | | | | | |
| between | | | | | |
| [5° C., | | | | | |
| 20° C.] | | | | | |

Table 4 shows that the performance deviations in terms of workability and hardening of the concretes (C) and (D) formulated with a binder according to the invention, are small, whatever the implementation working temperature of the concretes, between 5° C. to 20° C.,

On the contrary, the performance deviations in terms of workability and hardening of the concretes (A) and (B) formulated with a binder comprising respectively an alumina (A) (BET=0.9 m²/g) or an alumina (B) (BET=7.5 m²/g) not complying with the invention, are significant when the implementation temperature varies between 5° C. and 20° C.

The applicant has thus shown that when the working implementation temperature of the concrete varies between 5° C. and 20° C., the concretes (C) and (D), formulated with a binder according to the invention exhibit reduced performance deviations in terms of workability and hardening even when the implementation temperature varies.

### Example 3

Example 3 illustrates the characteristics of different concretes (A), (B), (C) and (D) formulated with the silica fumes FS(V) and FS(W), at 5° C., wherein the adjuvantation used is the same, i.e. that of the binder according to the invention.

Table 5 shows that the performance deviations in terms of workability and hardening of the concretes (C) and (D) formulated with a binder according to the invention, implemented at 5° C., are small, whatever the type of silica fume, FS(V) or FS(W), used. Conversely, the performance deviations in terms of workability and hardening of the concretes (A) and (B) formulated with a binder comprising respectively an alumina (A) (BET=0.9 m²/g) or an alumina (B) (BET=7.5 m²/g) not complying with the invention, implemented at 5° C., are significant when the type of silica fume used varies.

The applicant has thus shown that when the working implementation temperature of the concrete is low (5° C.), the concretes (C) and (D), formulated with a binder according to the invention exhibit reduced performance deviations in terms of workability and hardening even when the type of silica fume used varies.

TABLE 5

| | | Prior art | | Invention | |
|---|---|---|---|---|---|
| | | Concrete | Concrete | Concrete | Concrete |
| 5° C. | | (A) | (B) | (C) | (D) |
| flow To (mm) | FS(V) | 248 | 242 | 222 | 226 |
| | FS(W) | 248 | 238 | 215 | 213 |
| Working time | FS(V) | 8.8 | 8 | 3 | 3.2 |
| (h) | FS(W) | 29.6 | 18.0 | 6.7 | 5.2 |
| Toff (h) | FS(V) | 8 | 7.5 | 2 | 2.1 |
| | FS(W) | 25 | 17.6 | 6.5 | 3.6 |
| Δ Toff (h) | | 17 | 10.1 | 4.5 | 1.5 |
| Rc at 6 h | FS(V) | 0 | 0 | 9.1 | 10.9 |
| (Mpa) | FS(W) | 0 | 0 | 0 | 6.9 |
| Rc at 24 h | FS(V) | 14.3 | 16.9 | 17.6 | 18.6 |
| (Mpa) | FS(W) | 0 | 12.8 | 19.1 | 19 |

The parameters shown in examples 1 to 3 have been measured according to the operating procedures described below:

flowT0 (mm): spreading measure (Flow) according to the EN1402-4 European standard.

A truncated mould with a large base (100 mm), small base (70 mm) and 50 mm in height is filled with concrete. The flow of concrete is measured on a vibrating table under the following conditions:

Vibration: 0.5 mm amplitude associated with 50 Hz frequency for 30 seconds.

The Flow To value (mm) corresponds to the average diameter of the concrete disk at the initial time, just after mixing.

The Flow T15 value (mm) corresponds to the average of the concrete disk after 15 minutes.

Each flow measurement has been performed according to the same operating procedure, by using identical concrete masses, and identical residence times on the vibrating table. Thus, all the FlowT0 values may be compared to one another.

Workability (h) or Working Time:

Workability or working time (WT) corresponds to the workability of concrete and hence to the time at the end of which it may not be set up any longer. This time is supposedly reached for a flow inferior to 140 mm.

Toff

The measurement of the Toff parameter is performed as follows:

The concrete is kept in a plastic cup (250 ml), placed in an insulating box.

The evolution of the temperature of concrete with time is monitored.

Toff (expressed in hours) corresponds to the time at the end of which the temperature of concrete has increased by 1° C. based on its initial temperature (beginning of the exothermic peak)

ΔToff: difference in hours between 2 Toff values

Rc: Compression mechanical strengths measured according to the

EN1402-5 European standard.

Rc at 6 h: compression mechanical strength after 6 hours.

Rc at 24 h: compression mechanical strength after 24 hours.

During compression, the tests are performed on prismatic test pieces of sizes 30 mm×30 mm×160 mm. The test pieces are kept in a chamber under controlled temperature and hygrometry (100% relative humidity and temperature variable between 5 and 20° C.).

1. A binder for refractory low-cement content concrete including silica fume, said binder comprising:
a ground mineral portion comprising 30% to 80% by weight based on the total weight of said ground mineral portion, a clinker comprising 60% to 80% Al₂O₃ by weight, and 40% or less CaO,
at least one setting accelerator,
at least one setting retarder,
at least one defloculating agent, and
wherein said ground mineral portion further comprises 20% to 70% by weight based on the total weight of said ground mineral portion, an under-calcinated alumina the BET specific surface of which ranges between 8 m²/g and 20 m²/g, and preferably between 10 m² /g and 15 m²/g.

2. A binder for concrete according to claim 1, wherein said under-calcinated alumina comprises 10% to 50% transition alumina by weight, the remainder being formed of alumina α.

3. A binder for concrete according to claim 1, wherein said ground mineral portion exhibits a Blaine specific surface of at least 7000 cm²/g.

4. A binder for concrete according to claim 1, wherein the setting accelerator is a lithium salt, preferably lithium carbonate.

5. A binder for concrete according to claim 1, wherein the setting retarder is a carboxylic acid, preferably citric acid.

6. A binder for concrete according to claim 1, wherein the defloculating agent is a polyacrylate, a polycarboxylate polyox (PCP) or a polyphosphate.

7. A preparation for low-cement content concrete comprising, before mixing:
15 to 90% by weight of a binder such as defined according to claim 1, based on the total weight of said preparation and,
10 to 85% by weight of silica fume, based on the total weight of said preparation.

8. A concrete comprising, before mixing:
60% to 90% by weight of aggregates based on the total weight of concrete,
2 to 10%, preferably 3 to 7% by weight of silica fume based on the total weight of concrete, and
2 to 20% of a binder as defined in claim 1, based on the total weight of concrete.

9. A method for making a binder for low-cement content concrete including silica fume, said method comprising the following steps:
(a) co-grinding a mineral portion comprising,
30 to 80% by weight of a clinker based on the total weight of said mineral portion, said clinker comprising 60% to 80% by weight of Al₂O₃, and 40% or less CaO,
20% to 70% by weight, based on the total weight of said mineral portion, an under-calcinated alumina the BET specific surface of which ranges between 8 m²/g and 15 m²/g, and preferably between 10 m²/g and 15 m²/g, in order to obtain a ground mineral a portion,
(b) mixing the ground mineral portion obtained with at least one setting accelerator, at least one setting retarder, and at least one defloculating agent.

10. A binder for concrete according to claim 2, wherein the setting accelerator is a lithium salt, preferably lithium carbonate.

11. A binder for concrete according to claim 2, wherein the setting retarder is a carboxylic acid, preferably citric acid.
